(19) United States
(12) Patent Application Publication
(10) Pub. No.: US 2007/0150599 A1
(43) Pub. Date: Jun. 28, 2007

(54) Generation of resource-usage profiles for application sessions of a number of client computing devices

(75) Inventors: Anindya Neogi, New Delhi (IN); Ravi Kothari, New Delhi (IN); Jain Rohit, New Delhi (IN)

Correspondence Address: Frederick W. Gibb, III;McGinn & Gibb, PLLC, Suite 304, 2568-A Riva Road, Annapolis, MD, 21401, US

(73) Assignee: International Business Machines Corporation, Armonk, NY (US)

(21) Appl. No.: 11/315,821

(22) Filed: Dec. 22, 2005

(51) Int. Cl. G06F 15/16

(52) U.S. Cl. 709/227

(57) ABSTRACT

Resource-usage profiles for application sessions of a number of client computing devices are generated, by aggregating profiles generated from application sessions running on the client computing devices. In particular, resource-usage information for application sessions is generated as the application sessions are generated within each client computing device of a number of client computing devices. Resource-usage profiles for application programs or application categories are then created based on this resource-usage information. Thus, at least one of the resource-usage profiles is based upon the resource-usage information generated by more than one of the client computing devices. Furthermore, a user may query the resource-usage profiles, so that the user is able to retrieve information regarding a desired application program as run on a number of the client computing devices. Additionally or alternatively, a computer program running on a client computing device may query the resource-usage profiles.

### FIELD OF THE INVENTION

The present invention relates to the generation of resource-usage profiles for application programs and application program categories, where such profiles are generated by aggregating profiles generated from one or more application sessions running on a number of client computing devices.

### BACKGROUND OF THE INVENTION

Application programs of a computing device use a variety of computing resources during their execution. These resources include processor time, storage space, memory space, and network bandwidth. A resource-usage profile of an application program can be considered a signature of how the application program uses such resources over its lifetime. The lifetime of an application program is the time period extending from when the application program was launched, or invoked, until when it was terminated, either voluntarily or by being forced to terminate. The lifetime of an application program is referred to herein as an application session. Under different circumstances, such as the load on the application program, its input data, and how a user interacts with the program, the resource-usage profile of an application program may vary. Thus, a given application program may have multiple and different resource-usage profiles for the different application sessions of the program.

Resource usage profiles can be derived for individual application programs or categories of application programs. A category may include multiple programs that have similar resource usage profiles. Henceforth, all references to application programs with respect to profile generation using clustering or other approaches relate to application programs as well as application program categories unless otherwise stated.

Resource-usage profiles can be used for a variety of purposes. The profiles may be employed for categorizing and characterizing different application programs. Application program developers can utilize resource-usage profiles to better understand their application programs. For instance, resource-usage profiles indicate how applications are used in real life and can be used to prioritize bug fixes or performance improvements.

Resource-usage profiles can also assist in provisioning resources within a multi-tasking environment of a computing device. For example, a policy-based controller can configure resource arbitrators based on resource-usage profiles. Resource-usage profiles may further be employed to assist in establishing prototypical behaviors of an application program, such that significant deviation from those behaviors may indicate the program has been compromised by a virus or other malware. For instance, a security system, such as an intrusion-detection system, can compare actual resource-usage profiles with prototypical profiles to identify anomalous behavior of an application program, which may have been compromised.

Existing resource-usage profile generation is based on observing the measurement data obtained from a single device. That is, resource-usage profiles are constructed for application programs running on a given computing device, and only the resource-usage profiles constructed in relation to that computing device are used by that computing device. The prior art thus provides no attempt to construct aggregated application-specific resource-usage profiles by collecting data from multiple computing devices. For this and other reasons, therefore, there is a need for the present invention.

### SUMMARY OF THE INVENTION

The present invention relates generally to generating resource-usage profiles for applications programs where such profiles are generated by aggregating profiles generated from one or more application sessions running on a number of client computing devices. A method of an embodiment of the invention includes generating resource-usage information for application sessions as the application sessions are generated within each client computing device of a number of client computing devices. Resource-usage profiles for the application programs are then created based on the resource-usage information generated within the client computing devices. Thus, at least one of the resource-usage profiles is based upon the resource-usage information generated by more than one of the client computing devices. The method also includes at least one of the following. First, a user may query the resource-usage profiles, so that he or she is able to retrieve information regarding a desired application program as run on a number of the client computing devices. Second, a policy-based resource arbitrator running on a client computing device may query the resource-usage profiles for a desired application program to promulgate an appropriate policy for running of the desired application program on that client computing device.

A computerized system of an embodiment of the invention includes a number of client computing devices and a centralized or distributed repository. The client computing devices each run an agent to monitor invocation, resource usage, and termination of application programs. The repository stores the resource-usage information generated within the client computing devices. The repository further stores resource-usage profiles created for the application programs, which are based on the resource-usage information generated within the client computing devices. As before, at least one of the resource-usage profiles is based upon the resource-usage information generated by more than one of the client computing devices. The repository may be a central repository, or it may be distributed over the client computing devices. The repository is queryable by a user and/or a computer program, such as a policy-based resource arbitrator running on a client computing device. The user may query the repository to retrieve information regarding a desired application program as run on a number of the client computing devices. The policy-based resource arbitrator or other computer program may query the repository to promulgate an appropriate policy for running a desired application program.

An article of manufacture of an embodiment of the invention includes a tangible computer-readable medium and means in the medium. The tangible computer-readable medium may be a recordable data storage medium, or another type of tangible computer-readable medium. The means is for collecting resource-usage information generated for application sessions by and within a number of client computing devices, and for creating resource-usage profiles for application programs based on the resource-usage information generated within the client computing devices. The means is further for enabling querying of the application sessions by a user and/or a policy-based resource arbitrator or other computer program running on a client computing device. The user may perform querying to retrieve information regarding a desired application program as run on a number of the client computing devices. The policy-based resource arbitrator or other computer program may perform querying to promulgate an appropriate policy for running a desired application program.

Embodiments of the invention provide for advantages over the prior art. The representation, filtering, and aggregation of resource-usage profiles within a repository allow such resource-usage profiles to be shared over the client computing devices that generated the profiles. As a result, the client computing devices can acquire socially constructed resource-usage profiles which can then be used to provide a better user experience. Still other advantages, aspects, and embodiments of the invention will become apparent by reading the detailed description that follows, and by referring to the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a diagram of a computerized system in which resource-usage profiles are generated based on the resource-usage information collected from a number of client computing devices, according to an embodiment of the invention.

FIG. 2 is a diagram of a computerized system in which resource-usage profiles are used to guide a policy-based controller in promulgating a resource-usage policy for an application program, according to an embodiment of the invention.

FIG. 3 is a flowchart of a method for generating and utilizing resource-usage profiles, according to an embodiment of the invention.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

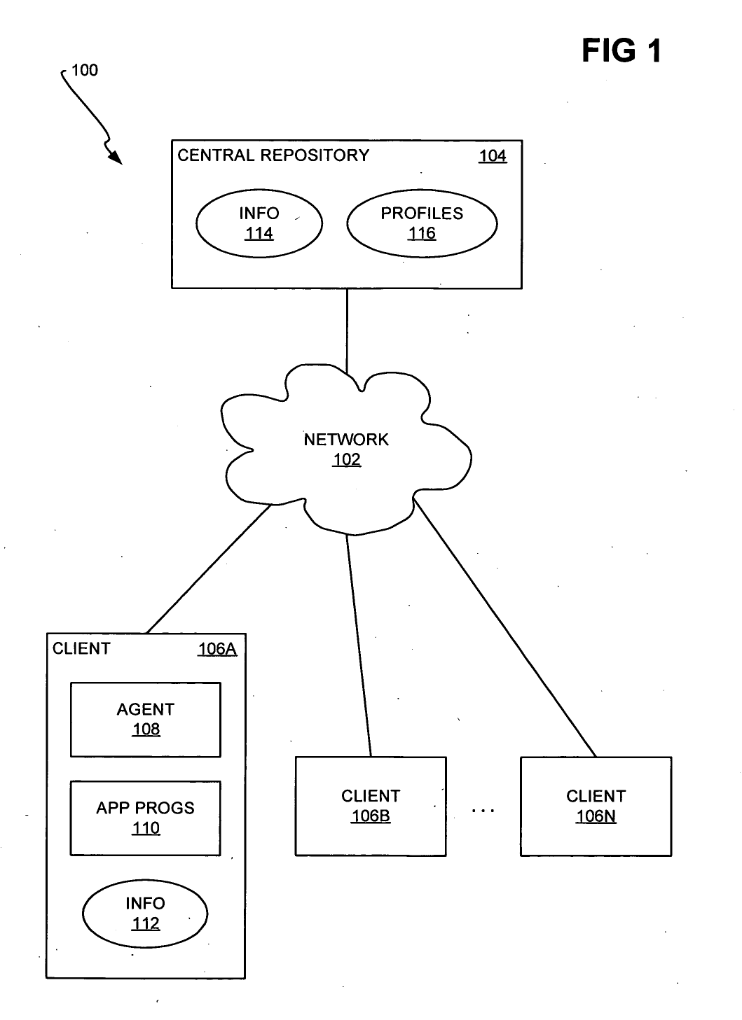

FIG. 1 shows a computerized system 100, according to an embodiment of the invention. The system 100 includes a network 102, a central repository 104, and a number of client computing devices 106A, 106B, . . . , 106N, collectively referred to as the client computing devices 106. The client computing devices 106 and the central repository 104 are each communicatively connected to the network 102. The network 102 may be or include a local-area network (LAN), a wide-area network (WAN), an intranet, an extranet, and the Internet, as well as other types of networks. The system 100 may include other components and devices, in addition to and/or in lieu of those depicted in FIG. 1.

The client computing devices 106 are each a computing device that typically includes one or more processors, memory, and storage devices such as hard disk drives, as can be appreciated by those of ordinary skill within the art. The client computing device 106A is depicted in detail in FIG. 1 as representative of all the client computing devices 106. Thus, the client computing device 106A includes an agent 108, one or more application programs 110, and resource-usage information 112.

The agent 108 continuously monitors the invocation and termination of the application programs 110. Therefore, the agent 108 is itself a computer program. The result of the invocation and termination of one of the application programs 110 is an application session of this application program. The agent 108, upon the invocation of one of the application programs 110, measures the resources used by the application program. Upon the termination of the application program, such that an application session of this application program results, the agent 108 generates resource-usage information for the application session in question. The agent 108 transmits the resource-usage information 112 for all such application sessions of the application programs 110 as the application sessions are generated to the central repository 104.

The central repository 104, or storage, stores the resource-usage information collected from the client computing devices 106 as the resource-usage information 114. Thus, the resource-usage information 114 represents such information regarding the application sessions of application programs running on the client computing devices 106. The resource-usage information 114 may include information regarding the same application program, as run on more than one of the client computing devices 106.

The central repository 104 generates or creates resource-usage profiles 116 for the application programs based on the resource-usage information 114 collected from the client computing devices 106. As has been stated in the background, a resource-usage profile of an application program can be considered a signature of how the application program uses such resources over its lifetime. Therefore, the central repository 104 is queryable as to the resource-usage profiles 116 created based on the resource-usage information 114.

For example, a user may query the central repository 104 to obtain information—i.e., one of the resource-usage profiles 116—regarding a desired application program as may have been run on a number of the client computing devices 106. Such a resource-usage profile is an aggregate profile, in that it reflects resource usage of the application program in question as has been run in a number of application sessions on a number of the client computing devices 106. As another example, a policy-based resource arbitrator or other computer program running on one of the client computing devices 106 may query the central repository 104. Such querying may be to promulgate an appropriate policy for the running of a desired application program on the client computing device in question. In this way, the policy-based resource arbitrator or other computer program leverages the resource usage of the application program in question within application sessions on other of the client computing devices 106, as is described in more detail later in the detailed description.

It is noted that the computerized system 100 as depicted in FIG. 1 is implemented in a client-server topology, in which the client computing devices 106 report resource-usage information to a central repository 104, which may be a server computing device. However, in another embodiment of the invention, the computerized system 100 may be implemented in a peer-to-peer, or distributed manner. In such an embodiment, the central repository 104 is a repository that is distributed over the client computing devices 106. The generation of the resource-usage profiles 116 is then accomplished by the individual client computing devices 106 themselves, as needed.

The agents of the client computing devices 106 periodically collect resource-usage monitoring data, or information, regarding the application programs running thereon, and send this information to the central repository 104, where it is stored as the resource-usage information 114. The repository 104 contains implementations of clustering and filtering methods and approaches. These methods analyze the resource-usage information 1 14 from multiple of the client computing devices 106 over multiple application sessions, and in response create the application resource-usage profiles 116. The profiles 116 may be stored using a predefined schema within the repository 104.

Users can participate and guide the profile labeling and selection process by providing structured feedback to the central repository 104 through one of the agents running on the client computing devices 106. Profiles corresponding to application programs can be labeled uniquely by using the program names, version numbers, and so on. Profiles corresponding to application categories, such as “word processing” or “video playback,” have to be labeled by the user based on a provided ontology. Furthermore, as an application of the resource-usage profiles 116, a policy-based controller can query the central repository 104 to receive an ordered set of the k nearest resource-usage profiles that match a local instance of an application program. The controller can then configure local resource schedulers using this information, as is described in more detail later in the detailed description.

In one embodiment, the agents running on the client computing devices 106 periodically monitor the resources used by an application program and reports the following static information to the central repository 104 for each application session of the application program.
1) Name of the executable file used to launch the application program;
2) Version number of the application program if known; and,
3) One or more attributes of the executable file.
   The attributes of the executable file may include the size of the file, as well as other known properties, such as the manufacturer of the file. Such information may be employed to derive a version number where the version number is not explicitly known. All of this static information is static insofar as it does not change for each application session of the application program in question.

The agents may further report dynamic information to the central repository 104 for each application session of the application program. The dynamic information may include a resource-usage trace having a set of 5-tuples, each of the form {(cᵢ,nᵢ,dᵢ,mᵢ,tᵢ)}ᵢ₌₀^{N}, where cᵢ denotes processor usage, nᵢ denotes network usage, dᵢ denotes disk usage, and mᵢ denotes memory usage within a time interval tᵢ−tᵢ₋₁, for each time interval tᵢ, i=0 . . . N. The processor usage may be specified in units such as the number of operations so as to be invariant as to the processor of a particular one of the client computing devices 106. The network usage, the disk usage, and the memory usage may be specified in bytes.

Furthermore, the dynamic information may include user feedback having a set of 4-types, each of the form {(s_{c},sₙ,s_{d},sₘ)}, where s_{c},sₙ,s_{d}, and sₘ are binary feedback values indicating whether a user is satisfied with the processor usage, the network usage, the disk usage, and the memory usage, respectively. That is, the dynamic information can include user feedback as to whether the user is satisfied with various aspects of the application session of the application program in question. Such satisfaction reporting can be restricted to once an application session in order to be as unobtrusive to the user as possible, but in other embodiments can be solicited more often. The user may further ignore the solicitation for satisfaction-related feedback. In another embodiment, more direct user feedback can also be provided on the profile at the central repository 104 itself, aggregated across multiple of the computing devices 106 and over multiple application sessions of the application programs.

The central repository 104 thus accepts resource-usage information from individual client computing devices 106. The repository 104 uses a relational structure which contains static resource-usage information such as the name of the application program, the name and the properties of the executable file. Other static information includes the version number, as well as the category and functionality of the application program, whether it is suspendable, whether it is primarily an interactive application program, and so on. Some of the information within the static portion of the repository 104 may require an external ontology and may be populated based on external sources of information. For instance, such an external source of information may indicate that a particular application program is a word processor, that is in interactive and not suspendable, and so on. The static information does not change with incoming resource-usage information from the client computing devices 106 other than the static information may be augmented by the information provided by the client computing devices 106.

The central repository 104 also stores dynamic resource-usage information received from the client computing devices 106, which is updated based on the information received from the devices 106. Multiple views of the information can be materialized and contained within the repository 104. Each such view may be depicted graphically as a tree, where node-splitting criteria of the individual trees can include functionality, resource-usage profile, and so on. The dynamic resource-usage information received from the client computing devices 106 may be stored in accordance with a clustering approach, such that the information generated by all the client computing devices 106 is combined at the repository 104 on a per-application program basis.

The dynamic content of the central repository 104 may further be updated based partitioning the multiple resource-usage information obtained for a given application program. One example of such partitioning is based on hierarchical clustering and time-series clustering, as known within the art. In a hierarchical form of clustering, each resource-usage profile begins as an independent cluster, and the most similar clusters are merged as one progresses up the hierarchy. Consequently, each level of the hierarchy presents one possible clustering solution, and appropriate heuristics, such as the homogeneity of the cluster, can be employed to stop further combination.

Once clustering is finished, methods to locate representative prototypes of each cluster can be employed. For example, collaborative filtering, as also known within the art, can be used. Such collaborative filtering relies on vector similarity, correlation coefficients, and so on, in order to obtain prototypical representatives of each cluster and thus of a resource-usage profile of a given application program. Thus, the dynamic resource-usage information received from the client computing devices 106 may be filtered to provide a prototypical representation of a resource-usage profile for a given application program. The prototypical representation of the profile may be updated as additional resource-usage information is generated.

Finally, users may provide direct feedback on cluster representatives (i.e., prototypical representatives of resource-usage profiles for a given application program). Therefore, the clusters themselves can be ranked by using a voting mechanism, such as a majority vote as to which resource-usage profile for a given application program is “best,” or by using a weighted combination voting approach. Where the feedback is based on the individual application sessions of an application program, such feedback can be incorporated into the clustering algorithm itself.

As has been noted, a user, through one of the client computing devices 106, may query the central repository 104 to obtain an aggregate resource-usage profile for a desired application program that has run on more than one of the client computing devices 106. Furthermore, a policy-based controller, which is also referred to herein as a policy-based resource arbitrator, or another computer program, running on one of the client computing devices 106 may query the central repository 104. This latter querying may be accomplished so that the controller can promulgate an appropriate policy for running a desired application program. That is, the controller can promulgate an appropriate policy for the usage of resources of a given application program, based on the resource-usage profile for that application program as has been constructed based on resource-usage information collected from a number of the client computing devices 106.

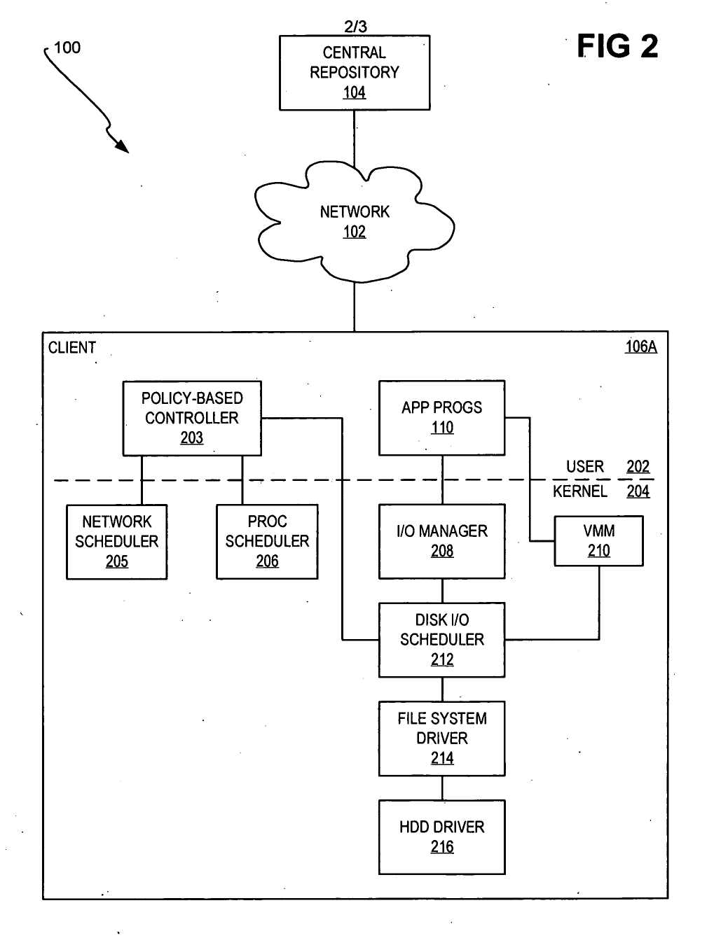

FIG. 2 shows the computerized system 100, according to another embodiment of the invention, in which the client computing device 106A includes such a policy-based controller 203. The system 100 again includes the central repository 104, but its details are omitted in FIG. 2 for illustrative clarity and convenience. Both the repository 104 and the client computing device 106A are communicatively connected to the network 102, as before. The client computing devices 106, except for the client computing device 106A, are also not depicted in FIG. 2 for illustrative clarity and convenience.

The client computing device 106A is divided into a user mode 202 and a kernel mode 204. Application programs, such as the application program 110, run in the user mode 202, whereas components of an operating system (OS) run in the kernel mode 204. Such components include the network scheduler 205, the processor scheduler 206, the input/output (I/O) manager 208, the virtual memory manager (VMM) 210, the disk I/O scheduler 212, the file system driver 214, and the hard disk drive driver 216. The user mode 202 and the kernel mode 204 can be considered as the two operating modes of the client computing device 106A. Application programs that run in the user mode 202 have access only to an address space provided within the user mode 202, so that when a user-mode process requires data that resides in the kernel mode 204, it calls a system service to obtain that data.

The distinction between user mode 202 and kernel mode 204 is made so that a certain amount of protection, or security, can be provided to the critical system processes that run in the kernel mode 204, so that these processes may not be directly affected from within the user mode 202. The kernel mode 204 thus contains the kernel of the client computing device 106A, which is the fundamental part thereof, including the OS, that provides basic services to the application programs running within the user mode 202.

The network scheduler 205 schedules how often and when the application programs 110 are allowed to use the network resources of the client computing device 106A, whereas the processor scheduler 206 schedules how often and when the application programs 110 are allowed to use the processor(s) of the client computing device 106A. The I/O manager 208 manages read and write requests from the application programs 110, which in turn are reordered by the disk I/O scheduler 212 based on the application programs in question that generated them, and ultimately submitted in accordance with the schedule of the scheduler 212 to the file system driver 214. The file system driver 214 is the driver that manages the file system, such as the NT file system in the case of some versions of the Microsoft Windows® operating system. The file system driver 214 in turn manages I/O access to a hard disk drive via the hard disk drive driver 216.

Similarly, memory mapped file I/O by the application programs 110 is handled by the VMM 210. Because virtual memory includes data that is stored on a hard disk drive in addition to volatile semiconductor memory, the VMM 210 sends I/O requests at some times to the disk I/O scheduler 212. The disk I/O scheduler 212 processes and reorders these requests based on the application programs in question that generated them, and submits them to the file system driver 214, which interacts with the hard disk drive driver 216 as appropriate. It is noted that the hard disk drive, semiconductor memory, and the processors of the client computing device 106A are not actually depicted in FIG. 2.

Contention of local resources, such as processor time, hard disk drive space, and memory space, is one cause of perceived poor performance of a computing device like the client computing device 106A. A variety of different tasks and application programs 110 may be running on the client computing device 106A at the same time. These include management tasks, such as backups, virus scans, software updates, and disk compaction; user tasks, such as gaming application programs, document editing application programs, compilation application programs, and multimedia application programs; and, background tasks, such as mail replication, file hoarding, file downloads, and so on.

To manage such local resource contention, the policy-based controller 203 can promulgate policies that dictate how often and when the resources of the client computing device 106A are used by the various application programs 110. In accordance with these policies, the network scheduler 205, the processor scheduler 206, and the disk I/O scheduler 212 are informed by the policy-based controller 203 as to how often and when the application programs 110 receive access to the resources managed by the schedulers 205, 206, and 212. An example of such a policy-based controller is that described in the U.S. Pat. No. 6,799,208.

For resource-usage policies to be effective, they need to be promulgated based on accurate and adequate information as to how a given application program is likely to behave when executed. Therefore, the policy-based controller 203 is able to query the central repository 104, through the network 102, in order to obtain the resource-usage profile for a given application program, in order to determine the policy that is to be promulgated for the utilization of resources by that program. The policy-based controller 203, once it has obtained the resource-usage profile from the central repository 104, can promulgate the policy for the application program in question in accordance with the disclosure provided in U.S. Pat. No. 6,799,208. Thus, the benefit provided by an embodiment of the invention in this respect is that the resource-usage information on which basis the policy is promulgated by the controller 203 is the aggregate information encapsulated within a resource-usage profile generated and stored by the repository 104.

Therefore, in one embodiment, when one of the application programs 110 starts, the policy-based controller 203 queries the central repository 104, such as through the agent 108 of FIG. 1 that is not shown in FIG. 2, to obtain one or more resource-usage profiles that are applicable to the application program in question. The result of the query may be an ordered set of resource-usage profiles for the application program that most closely reflect the set of circumstances in which the application program is being executed within the client computing device 106A. The controller 203 utilizes these profiles to construct an appropriate policy for the execution of the application program. That is, the controller 203 correspondingly configures the resource schedulers 205, 206, and 212 in accordance with the resource-usage profiles received.

Periodically, or when a change occurs in measured parameters of the application program in question or the operating system of the client computing device 106A, the policy-based controller 203 can again query the central repository 104 to acquire resource-usage profiles that more closely reflect these new circumstances. For example, when the application program in question starts consuming more processor resources, or when it has been actively used for a long period of time, it may be desirable to re-query the central repository 104. The new resource-usage profiles received in response can then be employed by the controller 203 to promulgate a policy concerning resource utilization by the application program that better reflects the new set of circumstances surrounding execution of the application program.

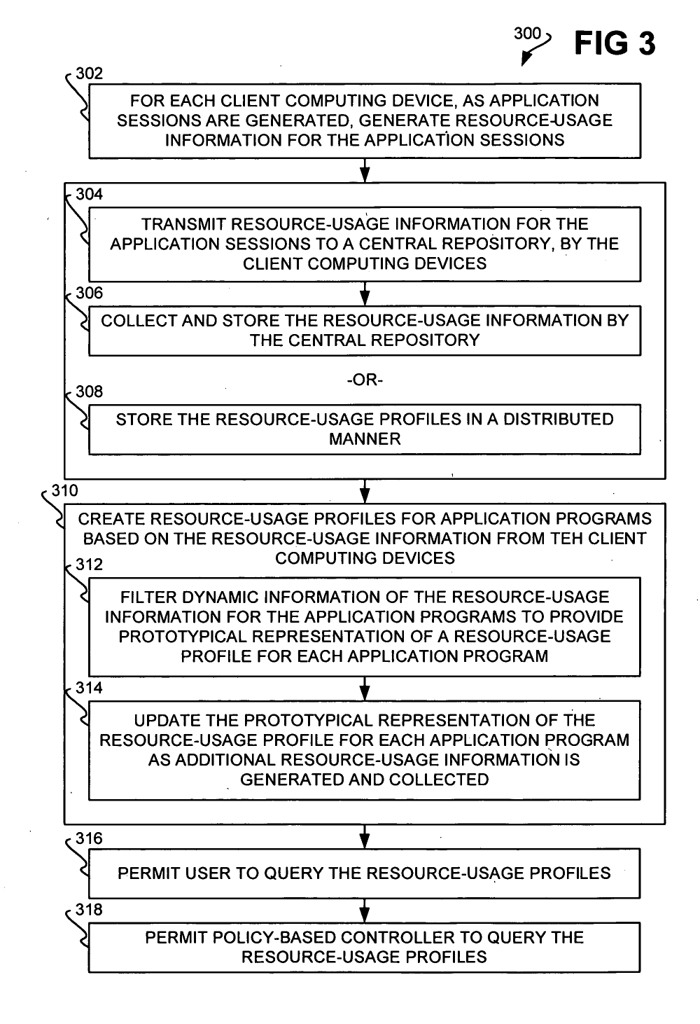

FIG. 3 shows a method 300 that summarizes the collection of resource-usage information and the generation of resource-usage profiles for application programs on an aggregate basis that has been described above, according to an embodiment of the invention. First, for or at each client computing device, as application sessions are generated, resource-usage information for the application sessions are generated or collected by an agent running on the client computing device (302). Next, either 304 and 306 may be performed, or 308 may be performed. In a client-server system topology, the resource-usage information for the application sessions is transmitted from each client computing device (by the agent thereof) to a central repository (304), which collects and stores the resource-usage information (306). Alternatively, in a peer-to-peer or distributed system topology, the resource-usage profiles are stored at the client computing devices themselves in a distributed manner (308).

Resource-usage profiles for application programs are then created or generated in aggregate, based on the resource-usage information received from the client computing devices (310), as has been described. For instance, in one embodiment, the dynamic information of the resource-usage information for the application programs may be filtered and/or clustered, to provide a prototypical representation of a resource-usage profile for each application program (312). As additional resource-usage information is generated and collected, this prototypical representation is updated for each application program (314).

Finally, a user is permitted to query the resource-usage profiles (316), as has been described. Thus, the user is able to retrieve information regarding a desired application program as has been run on a number of the client computing devices. Similarly, a policy-based controller, or policy-based resource arbitrator, or other computer program, running on one of the client computing devices is also permitted to query the resource-usage profiles (318). Thus, the controller can use the received resource-usage profile(s) to promulgate an appropriate policy for running a desired application program on its computing device.

It is noted that, although specific embodiments have been illustrated and described herein, it will be appreciated by those of ordinary skill in the art that any arrangement calculated to achieve the same purpose may be substituted for the specific embodiments shown. This application is thus intended to cover any adaptations or variations of embodiments of the present invention. For instance, the methods that have been described may be implemented by one or more computer programs. The computer programs may be stored on a computer-readable medium, such as a recordable data storage medium, or another type of computer-readable medium. Therefore, it is manifestly intended that this invention be limited only by the claims and equivalents thereof.

1. A method comprising:
by each client computing device of a plurality of client computing devices,
as application sessions are generated within the client computing device, generating resource-usage information for the application sessions;
creating resource-usage profiles for application programs based on the resource-usage information generated within the client computing devices, such that at least one of the resource-usage profiles is based upon the resource-usage information generated by more than one of the client computing devices; at least one of:
a user querying the resource-usage profiles, such that the user is able to retrieve information regarding a desired application program as run on a number of the client computing devices; and,
a computer program running on one of the client computing devices querying the resource-usage profiles for a desired application program to retrieve information regarding the desired application program.

2. The method of claim 1, further comprising:
by each client computing device of the plurality of client computing devices, transmitting the resource-usage information for the application sessions to a central repository; and,
storing the resource-usage information for the application sessions generated by the client computing devices at the central repository, such that the user or the computer program queries the resource-usage profiles at the central repository.

3. The method of claim 2, wherein the resource-usage profiles are generated and stored using a predetermined schema.

4. The method of claim 1, further comprising storing the resource-usage information for the application sessions generated by the client computing devices in a distributed manner among the client computing devices.

5. The method of claim 4, wherein the resource-usage information is stored in a distributed manner among the client computing devices using a predetermined schema.

6. The method of claim 1, wherein the resource-usage information for the application sessions are generated by an agent running on the client computing device and monitoring the invocation and termination of application programs.

7. The method of claim 1, wherein each resource-usage information comprises static information comprising at least one of:
a name of an executable file used to launch an application program;
a version number of the application program; and,
one or more attributes of the executable file.

8. The method of claim 1, wherein each resource-usage information comprises dynamic information.

9. The method of claim 8, wherein the dynamic information of each resource-usage information comprises a resource-usage trace having a set of 5-tupes, each of the form {(cᵢ,nᵢ,dᵢ,mᵢ,tᵢ)}ᵢ₌₁^{N}, where cᵢ denotes processor usage, nᵢ denotes network usage, dᵢ denotes disk usage, and mᵢ denotes memory usage within a time interval tᵢ−tᵢ₋₁, for each time interval tᵢ, i=1 . . . N.

10. The method of claim 8, wherein the dynamic information of each resource-usage information further comprises user feedback.

11. The method of claim 10, wherein the user feedback having a set of 4-types, each of the form {(s_{c},sₙ,s_{d},sₘ)}, where s_{c}, sₙ, s_{d}, and sₘ are binary feedback values indicating whether a user is satisfied with processor usage, network usage, disk usage, and memory usage, respectively.

12. The method of claim 8, wherein the dynamic information of each resource-usage information is stored in accordance with a clustering approach, such that the dynamic information of all the resource-usage information generated by all the client computing devices is combined on a per-application program or on an application category basis.

13. The method of claim 12, wherein the dynamic information is combined on the application category basis using a plurality of application categories, the application categories named based on an ontology obtained from external sources and stored in a repository.

14. The method of claim 12, further comprising, for each application program or application category for which resource-usage information have been generated, filtering the dynamic information of the resource-usage information for the application program or application category to provide a prototypical representation of a resource-usage profile for the application program or application category.

15. The method of claim 14, further comprising updating the prototypical representation of the resource-usage profile for the application program or application category as additional resource-usage information is generated for the application program or application category.

16. A computerizing system comprising:
a plurality of client computing devices, each client computing device running an agent to monitor invocation, resource usage, and termination of application programs; and,
a repository to store the resource-usage information generated within the client computing devices and to store resource-usage profiles for the application programs and application categories created based on the resource-usage information generated within the client computing devices, such that at least one of the resource-usage profiles is based upon the resource-usage information generated by more than one of the client computing devices, the repository queryable by at least one of:
a user, in order to retrieve information regarding a desired application program as run on a number of the client computing devices; and,
computer program running on one of the client computing devices.

17. The system of claim 16, wherein the repository comprises a central storage, to which the agent of each client computing device transmits the resource-usage information for the application sessions generated thereby.

18. The system of claim 16, wherein the repository is distributed over the client computing devices.

19. The system of claim 16, wherein each resource-usage information comprises a resource-usage trace having a set of 5-tupes, each of the form {(cᵢ,nᵢ,dᵢ,mᵢ,tᵢ)}ᵢ₌₁^{N}, where cᵢ denotes processor usage, nᵢ denotes network usage, dᵢ denotes disk usage, and mᵢ denotes memory usage within a time interval tᵢ−tᵢ₋ᵢ, for each time interval tᵢ, i=1 . . . N.

20. An article of manufacture comprising:
a computer-readable medium; tangibly embodying a computer program for executing a method comprising:
collecting resource-usage information generated for application sessions by and within a plurality of client computing devices;
creating resource-usage profiles for application programs based on the resource-usage information generated within the client computing devices; and
enabling querying of the resource-usage profiles by at least one of:
a user, in order to retrieve information regarding a desired application program as run on a number of the client computing devices, and,
a computer program running on one of the client computing devices.
